(19) United States
(12) Patent Application Publication
(10) Pub. No.: US 2026/0058861 A1
(43) Pub. Date: Feb. 26, 2026

(54) SYSTEM AND METHOD FOR TRACING NETWORK ISSUES

(71) Applicant: JIO PLATFORMS LIMITED, Ahmedabad (IN)

(72) Inventors: Aayush BHATNAGAR, Navi Mumbai (IN); Vikash AGRAWAL, Navi Mumbai (IN); Omprakash KUSHWAH, Madhya Pradesh (IN); Vikram LIMAN, Navi Mumbai (IN)

(73) Assignee: JIO PLATFORMS LIMITED, Ahmedabad (IN)

(21) Appl. No.: 18/880,352

(22) PCT Filed: Mar. 13, 2024
(86) PCT No.: PCT/IN2024/050256

§ 371 Date: Dec. 31, 2024

(30) Foreign Application Priority Data
Mar. 29, 2023 (IN) 202321023233

(51) Int. Cl. H04L 41/0631

(52) U.S. Cl. CPC H04L 41/0631

(57) ABSTRACT

The present disclosure provides a system (110) and a method (400) for network tracing using a command line interface (CLI) (112). The system (110) is integrated with the CLI (112) to provide location information of the concerned subscriber to an external client, trace requests from the subscriber in an efficient manner. The CLI (112) enables network tracing and subscriber tracing, thereby increasing efficiency to determine a root cause of a request failure from the subscriber.

A portion of the disclosure of this patent document contains material, which is subject to intellectual property rights such as but are not limited to, copyright, design, trademark, integrated circuit (IC) layout design, and/or trade dress protection, belonging to Jio Platforms Limited (JPL) or its affiliates (hereinafter referred as owner). The owner has no objection to the facsimile reproduction by anyone of the patent document or the patent disclosure, as it appears in the Patent and Trademark Office patent files or records, but otherwise reserves all rights whatsoever. All rights to such intellectual property are fully reserved by the owner.

### FIELD OF INVENTION

The embodiments of the present disclosure generally relate to systems and methods for network tracing and subscriber tracing in a telecommunication network. More particularly, the present disclosure relates to a system and a method for tracing network related issues using a command line interface that provides an accurate root cause analysis (RCA) during a request failure.

### BACKGROUND OF THE INVENTION

The following description of the related art is intended to provide background information pertaining to the field of the disclosure. This section may include certain aspects of the art that may be related to various features of the present disclosure. However, it should be appreciated that this section is used only to enhance the understanding of the reader with respect to the present disclosure, and not as admission of the prior art.

Fifth Generation (5G) wireless ecosystems are based on accurate location awareness and contextual information. Multiple user equipments (UEs) may access the 5G network via an access and mobility management function (AMF). Considering 5G, multiple applications may be running in a production environment where developers may be unable to access call data records (CDR) or clear code to determine the exact reason for a request failure from the UE.

There is, therefore, a need in the art to provide a system and a method that can mitigate the problems associated with the prior arts.

### OBJECTS OF THE INVENTION

Some of the objects of the present disclosure, which at least one embodiment herein satisfies are listed herein below.

It is an object of the present disclosure to provide a system and a method that uses a gateway mobile location centre (GMLC) with a command line interface (CLI) to enable network tracing and subscriber tracing in an efficient way.

It is an object of the present disclosure to provide a system and a method that uses the CLI to find a root cause of a request failure and further provides a detailed analysis.

It is an object of the present disclosure to provide a system and a method where the CLI traces a particular subscriber unified permanent identifier (SUPI) which helps in determining a request failure.

It is an object of the present disclosure to provide a system and a method where the CLI determines the underlying cause of request failure in the GMLC via network tracing and subscriber tracing.

It is an object of the present disclosure to provide a system and a method that enables network tracing and subscriber tracing without affecting production in case of the request failure.

It is an object of the present disclosure to enhance the communication system.

### SUMMARY

The present disclosure discloses a system for tracing network issues associated with a network entity in real time. The system includes a command line interface (CLI), a unified data management (UDM), an access and mobility management function (AMF) and an operation, administration, and management (OAM) module. The CLI is configured to receive a plurality of requests from a network operator for providing at least one of a network trace, a subscriber trace, or a combination thereof. The CLI is further configured to generate a tracing id for each request of the plurality of received requests. The UDM is coupled with the CLI. The UDM is configured to receive the generated tracing id along with a list of required data from the CLI. The AMF is coupled with the UDM and the CLI. The AMF is configured to receive the tracing id along with a set of predefined parameters from the UDM and is further configured to transmit a response to the CLI along with a plurality of subscriber and network traces. The OAM module is configured to receive the response along with the plurality of subscriber and network traces from the CLI and determine at least one cause of failure of the tracing id based on the plurality of subscriber and network traces in the network entity.

In an embodiment, the network entity is a gateway mobile location centre (GMLC).

In an embodiment, the system includes a database configured to store the plurality of subscriber and network traces.

In an embodiment, the list of required data includes tracing id, SUPI, node name, request id, response code, outgoing request time, failure cause, origin host, request type, and location services (LCS) correlation id.

In an embodiment, the set of predefined parameters includes push_addr, error code, error data, location deferred request (LDR) reference number, and location quality of service (QoS).

In an embodiment, the CLI is coupled with an operations, administration, and maintenance (OAM) module via a Hypertext Transfer Protocol version 1 (HTTP1) protocol.

In an embodiment, the plurality of subscriber and network traces includes various information having a request identification (ID), a subscriber unified permanent identifier (SUPI), a failure cause, a node name, and a response type.

In an embodiment, the CLI is configured to enable a particular subscriber unified permanent identifier (SUPI) for a particular request.

In an embodiment, the at least one cause of failure includes an incorrect SUPI, fail authentication and authorization of the received request, privacy settings enabled by the subscriber, status of account of the subscriber and like so.

The present disclosure discloses a method for tracing network issues in a real time. The method includes receiving, by a command line interface (CLI), a plurality of requests from a network operator for providing at least one of a network trace, a subscriber trace, or a combination thereof. The method includes generating, by the CLI, a tracing id for each request of the plurality of received requests. The method includes forwarding, by the CLI, the generated tracing id to a unified data management (UDM) along with a list of required data. The method includes forwarding, by the UDM, the received tracing id to an access and mobility management function (AMF) along with a set of predefined parameters. The method includes transmitting, by the AMF, a response to the CLI along with a plurality of subscriber and network traces. The method includes determining, by an operation, administration, and management (OAM), based on the plurality of subscriber and network traces, at least one cause of failure of the tracing id in the network entity.

In an embodiment, the method further includes storing the plurality of subscriber and network traces in a database.

In an embodiment, the method further includes enabling a particular subscriber unified permanent identifier (SUPI) for a particular request.

In an embodiment, the method further includes coupling of the CLI with the operations, administration, and maintenance (OAM) module via a Hypertext Transfer Protocol version 1 (HTTP1) protocol.

### BRIEF DESCRIPTION OF DRAWINGS

The accompanying drawings, which are incorporated herein, and constitute a part of this disclosure, illustrate exemplary embodiments of the disclosed methods and systems which like reference numerals refer to the same parts throughout the different drawings. Components in the drawings are not necessarily to scale, emphasis instead being placed upon clearly illustrating the principles of the present disclosure. Some drawings may indicate the components using block diagrams and may not represent the internal circuitry of each component. It will be appreciated by those skilled in the art that disclosure of such drawings includes the disclosure of electrical components, electronic components, or circuitry commonly used to implement such components.

FIG. 1 illustrates an exemplary network architecture of a system for tracing network issues associated with a network entity in real time, in accordance with an embodiment of the present disclosure.

FIG. 2 illustrates an exemplary representation of the system, in accordance with an embodiment of the present disclosure.

FIG. 3 illustrates an exemplary architecture of a gateway mobile location centre (GMLC), in accordance with an embodiment of the present disclosure.

FIG. 4 illustrates an exemplary method for network tracing and subscriber tracing, in accordance with an embodiment of the present disclosure.

FIG. 5 is an illustration of a non-limiting example of details of computing hardware used in the system, in accordance with an embodiment of the present disclosure.

The foregoing shall be more apparent from the following more detailed description of the disclosure.

### LIST OF REFERENCE NUMERALS

100—Network Architecture
102-1, 102-2 . . . 102-N—Network operators
104-1, 104-2 . . . 104-N—Computing Devices
106—Network
110—System
112—Command Line Interface (CLI)
202—One or more processor(s)
204—Memory
206—A Plurality of Interfaces
208—Processing Engine
210—Data Acquisition Engine
212—Database
302—Network Management Station (NMS)
304, 402—Operations Administration and Maintenance (OAM) module
306—Database
308—Visited GMLC (VGMLC)
310, 404—GMLC
312—Interface NL3
314—Home GMLC (HGMLC)
316—Mobile Management Entity (MME)
318—Home Subscriber Service (HSS)
320, 408—Access and Mobility Management function (AMF)
322—Network Exposure Function (NEF)
324, 406—Unified Data Management (UDM)
326—Mobile Number Portability (MNP)
328—Short Message Peer to Peer (SMPP) module
330—Location Service (LCS)
510—External Storage Device
520—Bus
530—Main Memory
540—Read Only Memory
550—Mass Storage Device
560—Communication Port
570—Processor

### DETAILED DESCRIPTION

In the following description, for the purposes of explanation, various specific details are set forth in order to provide a thorough understanding of embodiments of the present disclosure. It will be apparent, however, that embodiments of the present disclosure may be practiced without these specific details. Several features described hereafter can each be used independently of one another or with any combination of other features. An individual feature may not address any of the problems discussed above or might address only some of the problems discussed above. Some of the problems discussed above might not be fully addressed by any of the features described herein. Example embodiments of the present disclosure are described below, as illustrated in various drawings in which like reference numerals refer to the same parts throughout the different drawings.

The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the disclosure as set forth.

Specific details are given in the following description to provide a thorough understanding of the embodiments. However, it will be understood by one of ordinary skill in the art that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Also, it is noted that individual embodiments may be described as a process that is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination can correspond to a return of the function to the calling function or the main function.

The word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive like the term “comprising” as an open transition word without precluding any additional or other elements.

Reference throughout this specification to “one embodiment” or “an embodiment” or “an instance” or “one instance” means that a particular feature, structure, or characteristic described in connection with the embodiment is included in at least one embodiment of the present disclosure. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

The terminology used herein is to describe particular embodiments only and is not intended to be limiting the disclosure. As used herein, the singular forms “a”, “an”, and “the” are intended to include the plural forms as well, unless the context indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any combinations of one or more of the associated listed items. It should be noted that the terms “mobile device”, “user equipment”, “user device”, “communication device”, “device” and similar terms are used interchangeably for the purpose of describing the invention. These terms are not intended to limit the scope of the invention or imply any specific functionality or limitations on the described embodiments. The use of these terms is solely for convenience and clarity of description. The invention is not limited to any particular type of device or equipment, and it should be understood that other equivalent terms or variations thereof may be used interchangeably without departing from the scope of the invention as defined herein.

As used herein, an “electronic device”, or “portable electronic device”, or “user device” or “communication device” or “user equipment” or “device” refers to any electrical, electronic, electromechanical, and computing device. The user device is capable of receiving and/or transmitting one or parameters, performing function/s, communicating with other user devices, and transmitting data to the other user devices. The user equipment may have a processor, a display, a memory, a battery, and an input-means such as a hard keypad and/or a soft keypad. The user equipment may be capable of operating on any radio access technology including but not limited to IP-enabled communication, Zig Bee, Bluetooth, Bluetooth Low Energy, Near Field Communication, Z-Wave, Wi-Fi, Wi-Fi direct, etc. For instance, the user equipment may include, but not limited to, a mobile phone, smartphone, virtual reality (VR) devices, augmented reality (AR) devices, laptop, a general-purpose computer, desktop, personal digital assistant, tablet computer, mainframe computer, or any other device as may be obvious to a person skilled in the art for implementation of the features of the present disclosure.

Further, the user device may also comprise a “processor” or “processing unit” includes processing unit, wherein processor refers to any logic circuitry for processing instructions. The processor may be a general-purpose processor, a special purpose processor, a conventional processor, a digital signal processor, a plurality of microprocessors, one or more microprocessors in association with a DSP core, a controller, a microcontroller, Application Specific Integrated Circuits, Field Programmable Gate Array circuits, any other type of integrated circuits, etc. The processor may perform signal coding data processing, input/output processing, and/or any other functionality that enables the working of the system according to the present disclosure. More specifically, the processor is a hardware processor.

As portable electronic devices and wireless technologies continue to improve and grow in popularity, the advancing wireless technologies for data transfer are also expected to evolve and replace the older generations of technologies. In the field of wireless data communications, the dynamic advancement of various generations of cellular technology are also seen. The development, in this respect, has been incremental in the order of second generation (2G), third generation (3G), fourth generation (4G), and now fifth generation (5G), and more such generations are expected to continue in the forthcoming time.

While considerable emphasis has been placed herein on the components and component parts of the preferred embodiments, it will be appreciated that many embodiments can be made and that many changes can be made in the preferred embodiments without departing from the principles of the disclosure. These and other changes in the preferred embodiment as well as other embodiments of the disclosure will be apparent to those skilled in the art from the disclosure herein, whereby it is to be distinctly understood that the foregoing descriptive matter is to be interpreted merely as illustrative of the disclosure and not as a limitation.

Developers are now unable to analyze charge data record (CDR) data in a 5G application operating in a production environment to ascertain the precise cause of a request failure. The CLI may be used to easily retrieve multiple subscriber and network traces (the necessary data) to perform subscriber and network tracing. With this information, one may analyze the production and determine the underlying reason for request failure.

The present disclosure provides a system and a method for network and subscriber tracing, enabling a network operator to determine the underlying cause of request failure in a Gateway Mobile Location Centre (GMLC).

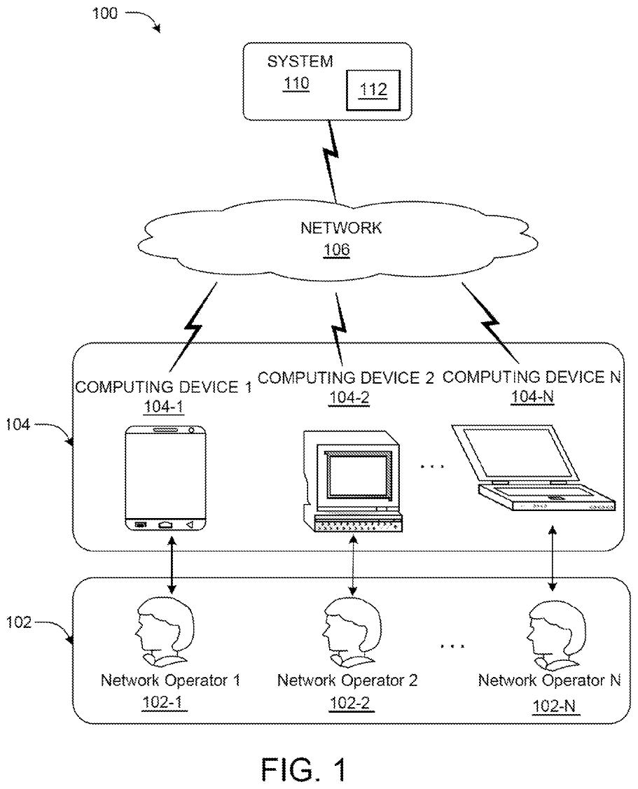

The various embodiments of the present disclosure will be explained in detail with reference to FIG. 1 to FIG. 5.

FIG. 1 illustrates an exemplary network architecture (100) of a system (110) for tracing network issues associated with a network entity in real time (also referred as “system 110”), in accordance with an embodiment of the present disclosure. In an embodiment, the network entity is a gateway mobile location centre (GMLC).

The system (110) includes a command line interface (CLI) (112), a unified data management (UDM), an access and mobility management function (AMF), and an operation, administration, and management (OAM) module. The command line interface (CLI) (112) is configured to receive a plurality of requests from a network operator for providing at least one of a network trace, a subscriber trace, or a combination thereof. The command line interface (CLI) (112) is further configured to generate a tracing id for each received request.

The unified data management (UDM) is coupled with the CLI (112). The UDM is configured to receive the generated tracing id along with a list of required data from the CLI (112). In an example, the list of required data includes SUPI, node name, request id, response code, outgoing request time, failure cause, origin host, request type, and location services (LCS) correlation id.

The access and mobility management function (AMF) is coupled with the UDM and the CLI (112). The AMF is configured to receive the tracing id along with a set of predefined parameters from the UDM. The AMF is further configured to transmit a response to the CLI (112) along with a plurality of subscriber and network traces. In an example, the set of predefined parameters includes push_addr, error code, error data, location deferred request (LDR) reference number, and location quality of service (QoS).

The OAM module is coupled with the CLI (112). In an example, the CLI (112) is coupled with the OAM module via a Hypertext Transfer Protocol version 1 (HTTP1) protocol. The OAM module is configured to receive the response along with the plurality of subscriber and network traces from the CLI (112). The OAM module determines at least one cause of failure of the tracing id in the network entity based on the plurality of subscriber and network traces. For example, the plurality of subscriber and network traces includes various information having a request identification (ID), a subscriber unified permanent identifier (SUPI), a failure cause, a node name, and a response type. In an example, the at least one cause of failure includes an incorrect SUPI, fail authentication and authorization of the received request, privacy settings enabled by the subscriber, status of account of the subscriber and like so.

As illustrated in FIG. 1, one or more computing devices (user devices) (104-1, 104-2, . . . , 104-N) are connected to the system (110) through a network (106). A person of ordinary skill in the art will understand that the one or more computing devices (104-1, 104-2 . . . 104-N) may be collectively referred as computing devices (104) and individually referred as computing device (104). One or more network operators (users) (102-1, 102-2 . . . 102-N) may operate the computing devices (104) for providing a plurality of requests to the system (110). In an example, the plurality of requests includes a network trace request, and a subscriber trace request. A person of ordinary skill in the art will understand that the one or more users (102-1, 102-2 . . . 102-N) may be collectively referred as users (102) and individually referred as user (102).

In an embodiment, the system (110) is integrated with or within a gateway mobile location centre (GMLC), therefore the system (110) also be referred as the gateway mobile location centre (GMLC) (110). The system (110) is configured with a command line interface (CLI) (112) for network tracing and subscriber tracing.

In an embodiment, the computing device (104) includes, but not be limited to, a mobile, a laptop, etc. Further, the computing device (104) includes one or more in-built or externally coupled accessories including, but not limited to, a visual aid device such as a camera, audio aid, microphone, or keyboard. Further, the computing device (104) includes a mobile phone, smartphone, virtual reality (VR) devices, augmented reality (AR) devices, a laptop, a general-purpose computer, a desktop, a personal digital assistant, a tablet computer, and a mainframe computer. Additionally, input devices for receiving input from a network operator (102) such as a touchpad, touch-enabled screen, electronic pen, and the like may be used.

In an embodiment, the network (106) includes, by way of example but not limitation, at least a portion of one or more networks having one or more nodes that transmit, receive, forward, generate, buffer, store, route, switch, process, or a combination thereof, etc. one or more messages, packets, signals, waves, voltage or current levels, some combination thereof, or so forth. The network (106) also includes, by way of example but not limitation, one or more of a wireless network, a wired network, an internet, an intranet, a public network, a private network, a packet-switched network, a circuit-switched network, an ad hoc network, an infrastructure network, a Public-Switched Telephone Network (PSTN), a cable network, a cellular network, a satellite network, a fiber optic network, or some combination thereof.

In an operative aspect, the CLI is configured to retrieve a plurality of information from the network entity (GMLC). In an example, the plurality of information includes network tracing data, subscriber tracing data, clear code data, and charging data record (CDR) data. In an example, the CLI is configured to enable a particular SUPI for a defined or a particular request.

In an aspect, the system (110) includes a database configured to store the plurality of subscriber and network traces.

In an embodiment, the GMLC acts as a first node that an external 5G location service (LCS) client accesses in a public land mobile network (PLMN). In an aspect, application functions (AFs) and network functions (NFs) also access the GMLC directly or via a network exposure function (NEF). The system (110) is configured to request routing information and/or target subscriber privacy information from a unified data management (UDM) via an interface. After performing authorization of the external LCS client or AF and verifying target subscriber privacy, the system (110) is configured to forward a location request to either a serving access and mobility management function (AMF) using an AMF service based Namf interface. The system (110) is configured to forward a request to a GMLC in another PLMN using a GMLC service based Ngmlc interface in case of a roaming subscriber.

In an embodiment, the system (110) is configured to authorize the external LCS client and support a request for periodic or triggered location received from the serving AMF for the target subscriber.

In an embodiment, the system (110) is configured to receive an immediate location request from the LCS client, AF, or NEF. An immediate location request is used for a network induced-location request (NI-LR), a mobile terminating-location request (MT-LR), or a mobile originating-location request (MO-LR).

In an embodiment, the system (110) is configured to defer the location request from the LCS client, AF, or NEF where the deferred location request may be only requested for the MT-LR.

In an embodiment, the system (110) is configured to enable multiple requests for multiple subscribers'location requests from the LCS client, AF, or NEF. Further, the system (110) is configured to process subscriber location requests via a Diameter interface.

Although FIG. 1 shows exemplary components of the network architecture (100), in other embodiments, the network architecture (100) may include fewer components, different components, differently arranged components, or additional functional components than depicted in FIG. 1. Additionally, or alternatively, one or more components of the network architecture (100) may perform functions described as being performed by one or more other components of the network architecture (100).

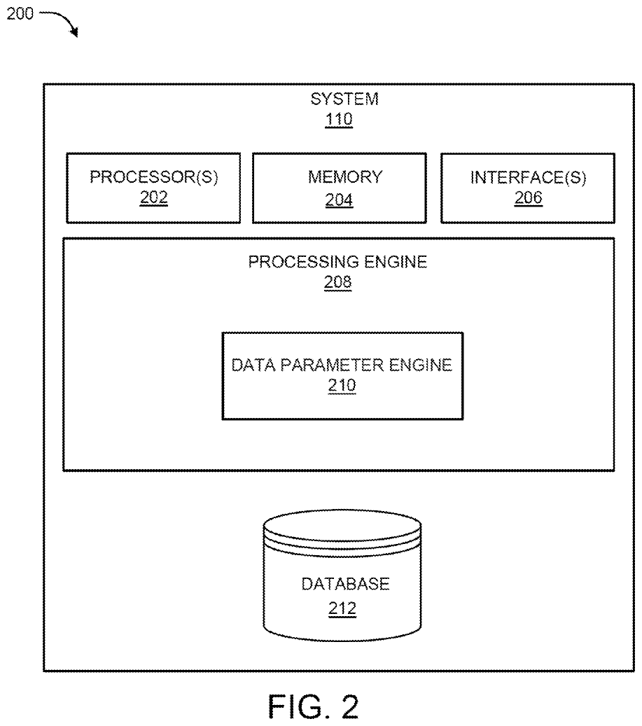

FIG. 2 illustrates an exemplary representation (200) of the system (110), in accordance with an embodiment of the present disclosure.

Referring to FIG. 2, the system (110) includes one or more processor(s) (202). The one or more processor(s) (202) may be implemented as one or more microprocessors, microcomputers, microcontrollers, digital signal processors, central processing units, logic circuitries, and/or any devices that process data based on operational instructions. Among other capabilities, the one or more processor(s) (202) is configured to fetch and execute computer-readable instructions stored in a memory (204) of the system (110). The memory (204) is configured to store one or more computer-readable instructions or routines in a non-transitory computer readable storage medium, which may be fetched and executed to create or share data packets over a network service. The memory (204) may comprise any non-transitory storage device including, for example, volatile memory such as random-access memory (RAM), or non-volatile memory such as erasable programmable read only memory (EPROM), flash memory, and the like.

In an embodiment, the system (110) includes an interface(s) (206). The interface(s) (206) may comprise a variety of interfaces, for example, interfaces for data input and output devices (I/O), storage devices, and the like. The interface(s) (206) facilitates communication through the system (110). The interface(s) (206) also provides a communication pathway for one or more components of the system (110). Examples of such components include, but are not limited to, processing engine(s) (208) including a data acquisition engine (210), and a database (212).

The processing engine(s) (208) may be implemented as a combination of hardware and programming (for example, programmable instructions) to implement one or more functionalities of the processing engine(s) (208). In examples described herein, such combinations of hardware and programming may be implemented in several different ways. For example, the programming for the processing engine(s) (208) may be processor-executable instructions stored on a non-transitory machine-readable storage medium and the hardware for the processing engine(s) (208) may comprise a processing resource (for example, one or more processors), to execute such instructions. In the present examples, the machine-readable storage medium may store instructions that, when executed by the processing resource, implement the processing engine(s) (208). In such examples, the system may comprise the machine-readable storage medium storing the instructions and the processing resource to execute the instructions, or the machine-readable storage medium may be separate but accessible to the system and the processing resource. In other examples, the processing engine(s) (208) may be implemented by electronic circuitry.

In an embodiment, the processor (202) receives one or more requests from a UE (104) via the data acquisition engine (210). The processor (202) is configured to store the one or more requests in the database (212).

In an embodiment, the processor (202) is configured with a CLI to receive at least one, but not limited to, a network tracing and a subscriber tracing request associated with the subscriber.

In an embodiment, the CLI generates one or more data that includes a request identification (ID), a subscriber unified permanent identifier (SUPI), a failure cause, a node name, and a response type. The generated one or more data is used in determining a root cause associated with a request failure. In an example, the data is used to determine at which node the request was failed.

In an embodiment, the processor (202) generates an analysis based on the generated one or more data to determine the request failure associated with the subscriber.

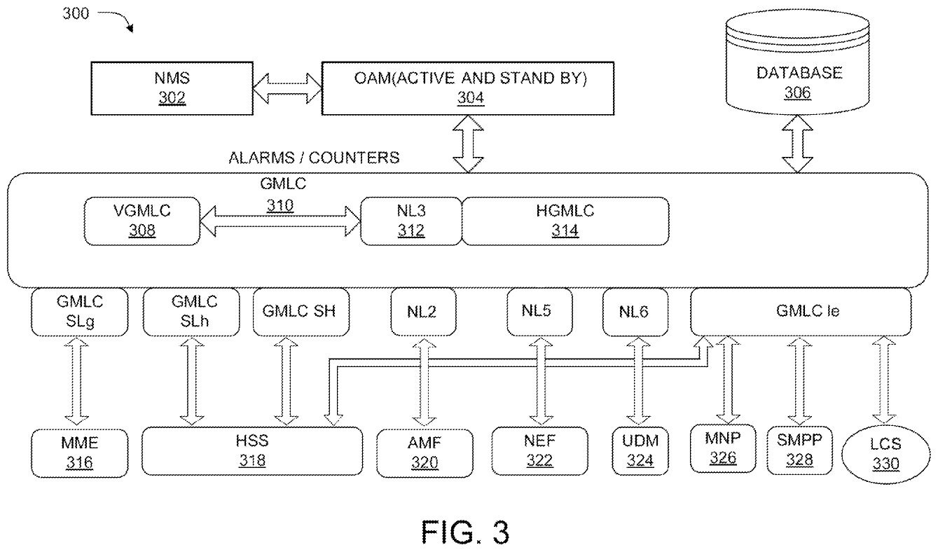

FIG. 3 illustrates an exemplary architecture (300) of the GMLC (310), in accordance with an embodiment of the present disclosure.

In an embodiment, as illustrated in FIG. 3, the GMLC is connected to a network management station (NMS) (302), an operations administration and maintenance (OAM) module (304), and a database (DB) (306). Further, the GMLC (310) is connected to a home GMLC (HGMLC) (314) via an interface NL3 (312). The GMLC (310) is also connected to a visited GMLC (VGMLC) (308).

In an embodiment, as illustrated in FIG. 3, the GMLC (310) is connected to a mobile management entity (MME) (316), a home subscriber service (HSS) (318), and an AMF (320). Further, the GMLC (310) is connected to a NEF (322), a UDM (324), a mobile number portability (MNP) (326), a short message peer to peer (SMPP) module (328), and a LCS (330).

In an embodiment, the GMLC (310) provides a standard immediate location service for requesting the location of the subscribers. The service is used when a single location response is required immediately (within a set time) or when several asynchronous location responses may be returned (until a predefined timeout limit is reached).

The exemplary architecture (300) of the GMLC (310) is advanced in nature due to the presence of plurality of sub-GMLC micro services (sub nodes of a GMLC), attached individually with different nodes, specifically for each of the external connected nodes and thereby the architecture (300) of Gateway Mobile Location Centre (GMLC) is a control plane system that interfaces with emergency, regulatory and commercial LCS clients and the operator's network to quickly and efficiently provide the location of a mobile device, required to support Location Based Services. Furthermore, all the sub GMLCs are connected with GMLC le for communicating the location information. In the architecture,

GMLC/g/SLh/SH are 4G request nodes, and NL2/NL5/NL6 are 5G nodes, however NL6 helps in determining the incoming request if it is 5G or 4G.

GMLC-LE: GMLC LE is the microservice that interact with LCS client for location services.

GMLC-NLS: GMLC NLS is the microservice that interact with UDM node for get-privacy-data and get-amfId request.

GMLC NLF: GMLC NLF is the microservice that interact with NEF node for location services.

GMLC NLT: GMLC NLT is the microservice that interact with AMF to get the location details from LMF.

GMLS SH: GMLC SH is the microservice that interact with HSS for UDR request.

GMLC SLG: GMLC SLG is the microservice that interact with MME to get location details from ESMLC.

GMLC SLH: GMLC SLH is the microservice that interact with HSS for RIR request.

In an embodiment, the GMLC (310) provides an emergency location immediate service which is used to retrieve the position of the subscriber that is involved in an emergency call or an emergency service.

In an embodiment, the GMLC (310) provides a triggered location reporting service which is used when an application wants the position of several subscribers to be tracked. The triggers may include, but not be limited to, a periodicity of reporting defined by an interval time, the subscriber action, and a change of area associated with the subscriber.

In an embodiment, the GMLC (310) generates one or more historic locations of the subscriber. A long period may be required before a response is sent to the LCS client as large number of locations may be reported. The LCS client may thus allow the location server to send the location responses, either at the time of the response to the request, or individually using one or more connections initiated by the location server.

In an embodiment, the GMLC (310) provides an alarm support and management through the CLI. Further, the GMLC (310) provide the CLI support for a fault, configuration, accounting, and performance (FCAP) management through the OAM module (304). The CLI includes a capability for loading the commands dynamically during runtime and stores the commands in a structure. Micro services commands are executed by the CLI for either a specific instance or all instances and displays their status.

In an embodiment, the OAM module (304) is a central entity whose primitive task is to receive alarm requests from various GMLC processes (via alarm agents) and publish them to an element management system (EMS) via a RESTful interface. The OAM module (304) is responsible for fault, performance measurements, and configuration management. The OAM (304) interacts with an NMS (Network Management System) for sending performance measurement counters. The OAM module (304) also interacts with the NMS (302) for configuration management. Configuration parameters in the GMLC (310) may be viewed, set, added, or deleted via the NMS user interface (UI). There may be two OAMs deployed in a GMLC cluster with a 1:1 redundancy. Active OAMs communicates with the NMS (302) via a virtual internet protocol (VIP), which is present on an active OAM module.

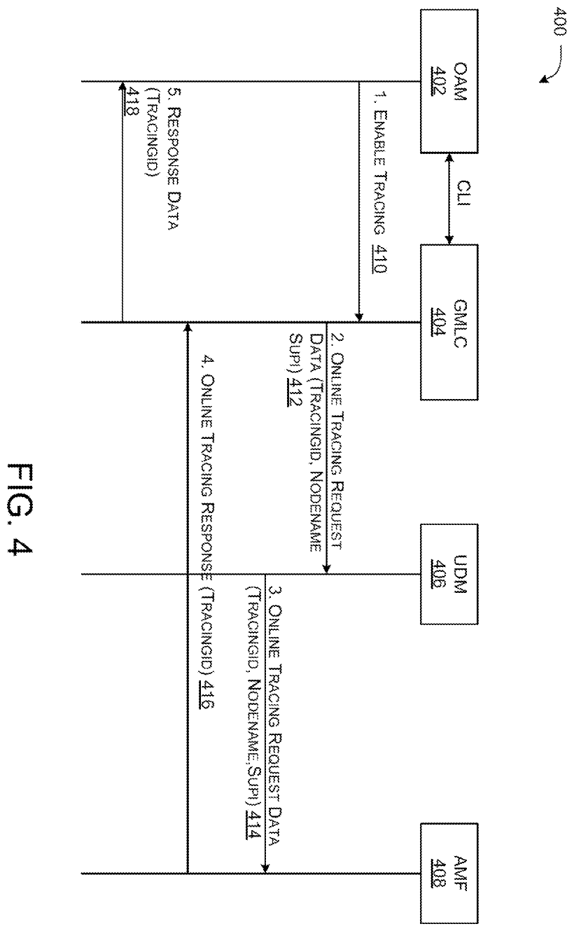

FIG. 4 illustrates an exemplary method (400) for network tracing and subscriber tracing, in accordance with an embodiment of the present disclosure.

In an embodiment, the system (110) and the GMLC (310) enable network tracing and subscriber tracing find the root cause of the request failure.

In an embodiment, the CLI generates subscriber and network traces that further generate data such as, but not limited to, a request ID, a SUPI, a failure cause, a node name, and a response type. The data may be used to find the root cause of the request failure and further provide an analysis of the production environment.

In an embodiment, as illustrated in FIG. 4, the CLI with connected tracing is enabled to trace a particular SUPI to disclose a system of a GMLC subscriber. Further, the CLI determines a request failure on a particular node like a LE (404) (GMLC's node), the UDM (406), and the AMF (408).

In an operative embodiment, the LE (404) includes a microservice to communicate with peer nodes like the LCS via one or more lawful intercept management systems (LIMS). The LE microservice manages a transaction via an LE interface for client authentication. Further, the LE micro services may be deployed in a GMLC cluster to manage traffic and enable equal distribution of load between the micro services. The LE microservice enables network tracing and subscriber tracing.

In an embodiment, the GMLC (310) is a network entity in the 5G core network, where the LE (404), the UDM (406), and the AMF (408) are the sub-nodes of the GMLC (310). The nodes may be interconnected with each other via one or more data structure streams.

As illustrated in FIG. 4, the following steps may be utilized for network tracing and subscriber tracing.
At step 410: Tracing is enabled by the CLI from the OAM (402) to the LE (404) or GMLC.
At step 412: An online tracing request data is sent by the LE (404) to the UDM (406). The tracing request data includes a tracing ID, a node name, and a SUPI.
At step 414: The online tracing request data is sent by the UDM (406) to the AMF (408). The tracing request data includes a tracing ID, a node name, and a SUPI.
At step 416: An online tracing response data is sent from the AMF (408) to the LE (404). The online tracing response data includes a tracing ID.
At step 418: The LE (404) sends a response data to the OAM (402). The response data includes the tracing ID.

In an embodiment, the OAM (402) and the CLI are connected to each other via a hypertext transfer protocol 1 (HTTP1). The OAM (402) and LE (404) nodes are connected via the one or more data structure streams. Further, tracing of a particular SUPI is enabled through the CLI which is connected to the OAM (402). The SUPI with the specific ID is sent to the LE (404).

In an embodiment, the LE (404) forwards the request to the UDM (406) along with the required data (tracing ID, SUPI, node name, request ID, response code, outgoing Request Time, Origin Host, request Type, LCS correlation ID, etc.). When the request is received at the UDM node (406), the UDM (406) forwards the request to the AMF (408) along with certain parameters like (push_addr, Error Code, Error Data, LDR Reference Number, Location QoS, etc.) via GetAmdIdFromUdmResponseHandler. Further, the request is sent to the AMF (408), which determines the root cause in the case of the request failure.

In an embodiment, as the request is received at the AMF node (408), the AMF (408) sends the response to LE (404) along with the tracing ID, response Status, response Code, failure Cause, outgoing Response Time, etc. Further, the LE (404) forwards the response data back to the OAM (402) along with the tracing ID.

In an exemplary embodiment, the node name specifies the particular node (e.g., LE, UDM, or AMF), where the request fails. The node name determines the possible reason for request failure at a specific node.

In an exemplary embodiment, the tracing ID is a unique ID corresponding to each request that helps in tracking a failure cause for a particular request.

In an exemplary embodiment, the SUPI is a unique identifier for a particular request.

In an exemplary embodiment, the outgoing Request Time is an exact sending time of a particular request. The outgoing Request Time helps in analyzing the time taken by the request to reach the specific node so that the reason for the request failure may be determined.

In an exemplary embodiment, the Origin Host specifies the client IP address and determine the cause of request failure for a particular client.

In an exemplary embodiment, the response Code is the status code which specifies the request status for a particular request.

In an exemplary embodiment, the request Type specifies the type of request like Standard Location Immediate Request (SLIR), Historic Location Immediate Request (HLIR), Emergency Location Immediate Request (ELIR), and Triggered Location Reporting Request (TLRR). The request type tracks a particular ID and analyzes the root cause through the specific request type at the LE (404).

In an exemplary embodiment, the LCS correlation ID is a unique ID of the LCS client.

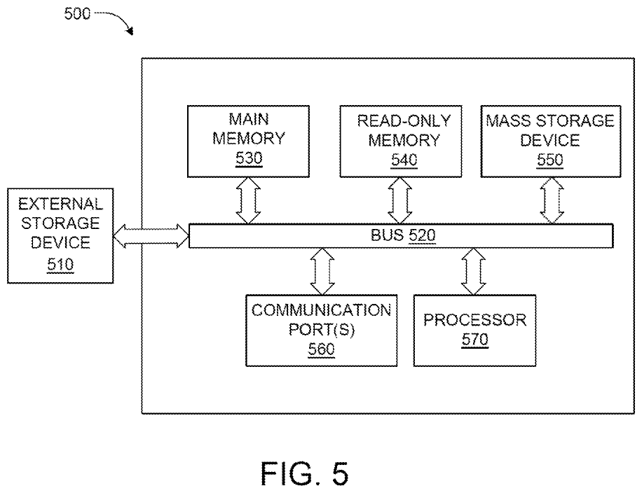

FIG. 5 is an illustration (500) of a non-limiting example of details of computing hardware used in the system, in accordance with an embodiment of the present disclosure. As shown in FIG. 5, the system (110) may include an external storage device (510), a bus (520), a main memory (530), a read only memory (540), a mass storage device (550), a communication port (560), and a processor (570). A person skilled in the art will appreciate that the system (212) may include more than one processor (570) and communication ports (560). Processor (570) may include various modules associated with embodiments of the present disclosure.

In an embodiment, the communication port (560) may be any of an RS-232 port for use with a modem-based dialup connection, a 10/100 Ethernet port, a Gigabit or 10 Gigabit port using copper or fiber, a serial port, a parallel port, or other existing or future ports. The communication port (560) may be chosen depending on a network, such a Local Area Network (LAN), Wide Area Network (WAN), or any network to which the computer system (500) connects.

In an embodiment, the memory (530) may be Random Access Memory (RAM), or any other dynamic storage device commonly known in the art. Read-only memory (540) may be any static storage device(s) e.g., but not limited to, a Programmable Read Only Memory (PROM) chips for storing static information e.g., start-up or Basic Input/Output System (BIOS) instructions for the processor (570).

In an embodiment, the mass storage (550) may be any current or future mass storage solution, which may be used to store information and/or instructions. Exemplary mass storage solutions include, but are not limited to, Parallel Advanced Technology Attachment (PATA) or Serial Advanced Technology Attachment (SATA) hard disk drives or solid-state drives (internal or external, e.g., having Universal Serial Bus (USB) and/or Firewire interfaces), one or more optical discs, Redundant Array of Independent Disks (RAID) storage, e.g., an array of disks (e.g., SATA arrays).

In an embodiment, the bus (520) communicatively couples the processor(s) (570) with the other memory, storage, and communication blocks. The bus (520) may be, e.g., a Peripheral Component Interconnect (PCI)/PCI Extended (PCI-X) bus, Small Computer System Interface (SCSI), Universal Serial Bus (USB) or the like, for connecting expansion cards, drives and other subsystems as well as other buses, such a front side bus (FSB), which connects the processor (570) to the computer system (500).

Optionally, operator and administrative interfaces, e.g., a display, keyboard, joystick, and a cursor control device, may also be coupled to the bus (520) to support direct operator interaction with the computer system (500). Other operator and administrative interfaces may be provided through network connections connected through the communication port (560). Components described above are meant only to exemplify various possibilities. In no way should the aforementioned exemplary illustration (500) limit the scope of the present disclosure.

The present disclosure is configured to provide an enhancement to the Gateway Mobile Location Centre (GMLC) such that the enhanced GMLC or system (110) is able to know an exact reason behind a request failure and ensures that appropriate steps are taken to improve the functionality of a network entity. Network tracing aids in identifying network issues and performance problems. It involves collecting and analyzing data from various sources to understand how network traffic flows and to identify issues such as latency or bandwidth utilization. Subscriber tracing focuses on tracking the movements and activities of individual subscribers on a network. The present disclosure is applicable to a wide range of applications that require real-time operation, including identifying nodes at which request failure occurred for improving network performance by optimizing the use of available resources.

The method and system of the present disclosure may be implemented in a number of ways. For example, the methods and systems of the present disclosure may be implemented by software, hardware, firmware, or any combination of software, hardware, and firmware. The above-described order for the steps of the method is for illustration only, and the steps of the method of the present disclosure are not limited to the order specifically described above unless specifically stated otherwise. Further, in some embodiments, the present disclosure may also be embodied as programs recorded in a recording medium, the programs including machine-readable instructions for implementing the methods according to the present disclosure. Thus, the present disclosure also covers a recording medium storing a program for executing the method according to the present disclosure.

While considerable emphasis has been placed herein on the preferred embodiments, it will be appreciated that many embodiments can be made and that many changes can be made in the preferred embodiments without departing from the principles of the disclosure. These and other changes in the preferred embodiments of the disclosure will be apparent to those skilled in the art from the disclosure herein, whereby it is to be distinctly understood that the foregoing descriptive matter is to be implemented merely as illustrative of the disclosure and not as a limitation.

### Advantages of the Invention

The present disclosure provides a system and a method that uses a gateway mobile location centre (GMLC) with a command line interface (CLI) to enable network tracing and subscriber tracing in an efficient way.

The present disclosure provides a system and a method that uses the CLI to find the root cause of a request failure and further provides a detailed analysis.

The present disclosure provides a system and a method where the CLI traces a particular subscriber unified permanent identifier (SUPI) which helps in determining a request failure.

The present disclosure provides a system and a method where the CLI determines the underlying cause of request failure in GMLC via network tracing and subscriber tracing.

The present disclosure provides a system and a method that enables network tracing and subscriber tracing without affecting production in case of the request failure.

The present disclosure provides a system and a method that enhances the communication system.

We claim:

1. A system (110) for tracing network issues associated with a network entity in real time, said system (110) comprising:
a command line interface (CLI) (112) configured to receive a plurality of requests from a network operator for providing at least one of a network trace, a subscriber trace or a combination thereof and is further configured to generate a tracing id for each received request;
a unified data management (UDM) (406), coupled with said CLI (112), configured to receive said generated tracing id along with a list of required data from said CLI (112);
an access and mobility management function (AMF) (408), coupled with said UDM (406) and said CLI (112), configured to receive said tracing id along with a set of predefined parameters from said UDM (406) and is further configured to transmit a response to said CLI (112) along with a plurality of subscriber and network traces; and
an operation, administration, and management (OAM) module (402) configured to receive said response along with said plurality of subscriber and network traces from said CLI (112) and determine at least one cause of failure of said tracing id in said network entity based on said plurality of subscriber and network traces.

2. The system (110) as claimed in claim 1, wherein said network entity is a gateway mobile location centre (GMLC) (404).

3. The system (110) as claimed in claim 1, includes a database (212) configured to store said plurality of subscriber and network traces.

4. The system (110) as claimed in claim 1, wherein said CLI (112) is configured to enable a particular subscriber unified permanent identifier (SUPI) for a particular request.

5. The system (110) as claimed in claim 1, wherein said list of required data includes SUPI, node name, request id, response code, outgoing request time, failure cause, origin host, request type, and location services (LCS) correlation id.

6. The system (110) as claimed in claim 1, at least one cause of failure includes an incorrect SUPI, fail authentication and authorization of said received request, privacy settings enabled by said subscriber, status of account of said subscriber and like so.

7. The system (110) as claimed in claim 1, wherein said set of predefined parameters includes push_addr, error code, error data, location deferred request (LDR) reference number, and location quality of service (QoS).

8. The system (110) as claimed in claim 1, wherein said CLI (112) is coupled with said operations, administration, and maintenance (OAM) module via a Hypertext Transfer Protocol version 1 (HTTP1) protocol.

9. The system (110) as claimed in claim 1, wherein said plurality of subscriber and network traces includes various information having a request identification (ID), a subscriber unified permanent identifier (SUPI), a failure cause, a node name, and a response type.

10. A method for tracing network issues associated with a network entity in a real time, said method comprising:
receiving, by a command line interface (CLI) (112), a plurality of requests from a network operator for providing at least one of a network trace, a subscriber trace or a combination thereof;
generating, by said CLI (112), a tracing id for each received request;
forwarding, by said CLI (112), said generated tracing id to a unified data management (UDM) (406) along with a list of required data;
forwarding, by said UDM (406), said received tracing id to an access and mobility management function (AMF) (408) along with a set of predefined parameters;
transmitting, by said AMF (408), a response to said CLI (112) along with a plurality of subscriber and network traces; and
determining, by an operation, administration, and management (OAM) (402), based on said plurality of subscriber and network traces, at least one cause of failure of said tracing id in said network entity.

11. The method as claimed in claim 10, further comprising storing said plurality of subscriber and network traces in a database (212).

12. The method as claimed in claim 10, further comprising enabling a subscriber unified permanent identifier (SUPI) for a particular request.

13. The method as claimed in claim 10, further comprising coupling of said CLI (112) with said operations, administration, and maintenance (OAM) module (402) via a Hypertext Transfer Protocol version 1 (HTTP1) protocol.

14. A computer program product comprising a non-transitory computer-readable medium comprising instructions that, when executed by one or more processors, cause the one or more processors to execute a method for tracing network issues associated with a network entity in a real time, said method comprising:
receiving, by a command line interface (CLI) (112), a plurality of requests from a network operator for providing at least one of a network trace, a subscriber trace or a combination thereof;
generating, by said CLI (112), a tracing id for each received request;
forwarding, by said CLI (112), said generated tracing id to a unified data management (UDM) (406) along with a list of required data;
forwarding, by said UDM (406), said received tracing id to an access and mobility management function (AMF) (408) along with a set of predefined parameters;
transmitting, by said AMF (408), a response to said CLI (112) along with a plurality of subscriber and network traces; and
determining, by an operation, administration, and management (OAM) (402), based on said plurality of subscriber and network traces, at least one cause of failure of said tracing id in said network entity.
